(19) United States
(12) Patent Application Publication
(10) Pub. No.: US 2008/0150884 A1
(43) Pub. Date: Jun. 26, 2008

(54) BACKLIGHT CONTROL UNIT

(75) Inventor: Ken ITO, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/958,197

(22) Filed: Dec. 17, 2007

(30) Foreign Application Priority Data
Dec. 26, 2006 (JP) 2006-350220

(51) Int. Cl. G02F 1/13357

(52) U.S. Cl. 345/102

(57) ABSTRACT

According to one embodiment, a gain output of only light emitting elements positioning at a center portion of a light emitting element region of a light emitting portion is increased by a gain adjusting filter in a backlight control unit, and therefore, it becomes possible to decrease an output of the light emitting elements at the center portion of which drive time becomes long when a contrast of a liquid crystal is optimized. Accordingly, a variation of deterioration between the light emitting elements can be suppressed effectively even when the light emitting elements at the center portion of which drive time is long and the light emitting elements at circumferential edges of which drive time is short are mixed at the light emitting portion.

### CROSS-REFERENCE TO RELATED APPLICATIONS

This application is based upon and claims the benefit of priority from Japanese Patent Application Publication No. P2006-350220, filed Dec. 26, 2006, the entire contents of which are incorporated herein by reference.

### BACKGROUND

1. Field

One embodiment of the invention relates to a backlight control unit.

2. Description of the Related Art

In recent years, a study of an art, in which luminance of a liquid crystal backlight is changed in accordance with an image displayed on a screen of a liquid crystal TV and so on, and thereby, an improvement of contrast and a reduction of power consumption are realized, has been advanced. Besides, a development of a direct lighting type backlight using light emitting elements in dot form such as an LED, different from a light guide plate type backlight using a tubular phosphor such as a conventional cold-cathode tube, has been advanced. When the light emitting elements in dot form are used, a lighting control in a divided area becomes possible, and therefore, a contrast improvement can be realized by changing the luminance between a dark portion and bright portion of the image.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing a configuration of a liquid crystal panel unit according to the an embodiment of the invention;

FIG. 2 is an exemplary view showing the configuration of the light emitting portion shown in FIG. 1 in the embodiment, in which (a) part shows an example when light emission amounts of light emitting elements at right and left end portions are suppressed, and (b) part shows an example when the light emission amounts of the light emitting elements at upper and lower end portions are suppressed;

FIG. 3 is an exemplary view showing the liquid crystal screen shown in FIG. 1 in the embodiment in which (a) part shows an example when black band-shaped portions are displayed at right and left end portions, and (b) part shows an example when the black band-shaped portions are displayed at upper and lower portions;

FIG. 4 is an exemplary graphic chart showing a relation between brightness and time in the light emitting element of the light emitting portion;

FIG. 5 is an exemplary view functionally showing a gain adjusting filter according to the embodiment of the present invention;

FIG. 6 is an exemplary side view showing a schematic configuration of the gain adjusting filter in FIG. 5 in the embodiment;

FIG. 7 is an exemplary view showing a light emission amount per one light emitting element at each region of the light emitting portion in the embodiment;

FIG. 8 is an exemplary view showing a backlight control unit according to another aspect in the embodiment, and

FIG. 9 is an exemplary view showing a backlight control unit according to still another aspect in the embodiment.

### DETAILED DESCRIPTION

Various embodiments according to the invention will be described hereinafter with reference to the accompanying drawings. In general, according to one embodiment of the invention, a backlight control unit according to the present invention is the one, in which plural light emitting elements are disposed at one surface side, a light emitting device irradiating light of the light emitting elements from a rear surface side of a liquid crystal is held, and an output of each light emitting element of the light emitting device is adjusted so that a contrast is optimized in accordance with a video display level of the liquid crystal, wherein densities of the light emitting elements are different between circumferential edges and a center portion at a light emitting element region where the light emitting elements of the light emitting device are disposed.

Or, in general, according to one embodiment of the invention, a backlight control unit according to the present invention is the one, in which plural light emitting elements are disposed at one surface side, a light emitting device irradiating light of the light emitting element from a rear surface side of a liquid crystal is held, and an output of each light emitting element of the light emitting device is adjusted so that a contrast is optimized in accordance with a video display level of the liquid crystal, wherein radiation directions of the light emitting elements at circumferential edges are inclined toward a center portion side of a light emitting element region at the light emitting element region where the light emitting elements of the light emitting device are disposed.

Or, in general, according to one embodiment of the invention, a backlight control unit according to the present invention in which plural light emitting elements are disposed at one surface side, a light emitting device irradiating light of the light emitting element from a rear surface side of a liquid crystal is held, and an output of each light emitting element of the light emitting device is adjusted so that a contrast is optimized in accordance with a video display level of the liquid crystal, includes: a gain adjusting filter disposed at a front surface of the light emitting device, and increasing a gain output of only the light emitting elements positioning at a center portion of a light emitting element region where the light emitting elements of the light emitting device are disposed, wherein an output of the light emitting elements positioning at the center portion of the light emitting element region is smaller than an output of the light emitting elements positioning at circumferential edges of the light emitting element region.

### FIRST EMBODIMENT

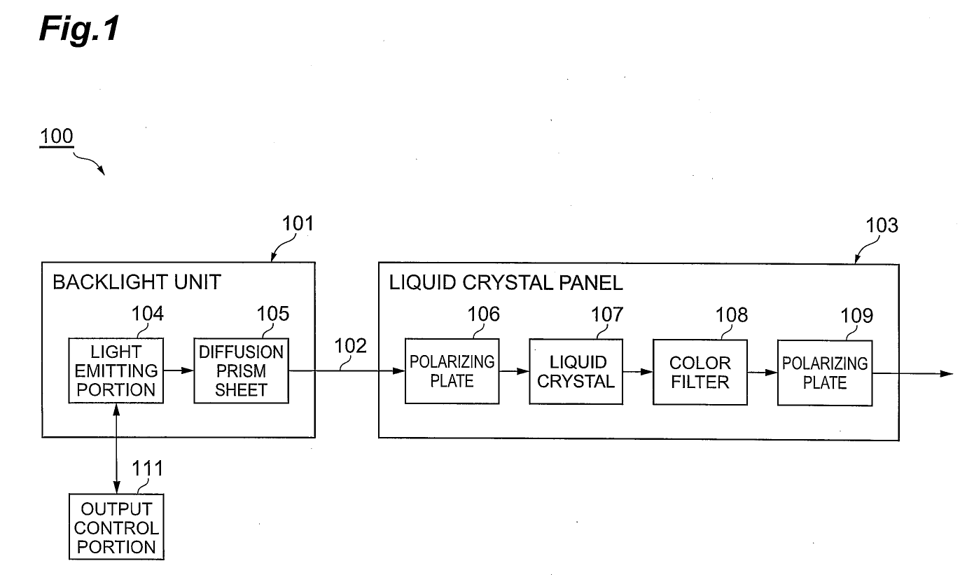

As shown in FIG. 1, a liquid crystal panel unit 100 according to a first embodiment of the present invention has a backlight unit 101 radiating light and a liquid crystal panel 103 to which a light 102 from the backlight unit 101 is irradiated.

The backlight unit 101 includes a light emitting portion (light emitting device) 104 and a diffusion prism sheet 105 equalizing the light of the light emitting portion 104, and the light 102 transmitting the diffusion prism sheet 105 is irradiated to the liquid crystal panel 103.

The liquid crystal panel 103 includes a pair of polarizing plates 106, 109, a liquid crystal 107 and a color filter 108 interposed between the pair of polarizing plates 106, 109. The light 102 incident to this liquid crystal panel 103 is polarized by the polarizing plate 106, and thereafter, incident to the liquid crystal 107. Further, the light 102 sequentially transmits the color filter 108, the polarizing plate 109, and outputs the light on the liquid crystal panel. Namely, the polarized light is controlled at a portion corresponding to each pixel of the liquid crystal 107, a transmission amount of light is adjusted at the polarizing plate 109, and further, the light is colored by the color filter 108 to output a video.

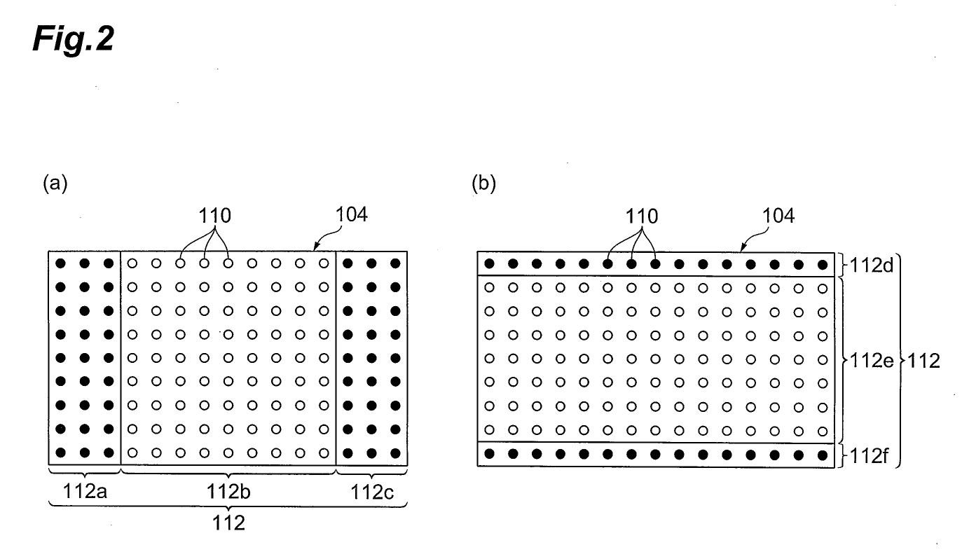

Plural light emitting elements (for example, LED) 110 are disposed at one surface side of the light emitting portion 104, as shown in FIG. 2. The plural light emitting elements 110 are disposed in a matrix state with equal intervals in both vertical direction and horizontal direction at a region (light emitting element region) where the light emitting elements 110 are disposed. Namely, the light emitting portion 104 irradiates the light of the light emitting elements 110 to the liquid crystal 107 from a rear surface side of the liquid crystal 107.

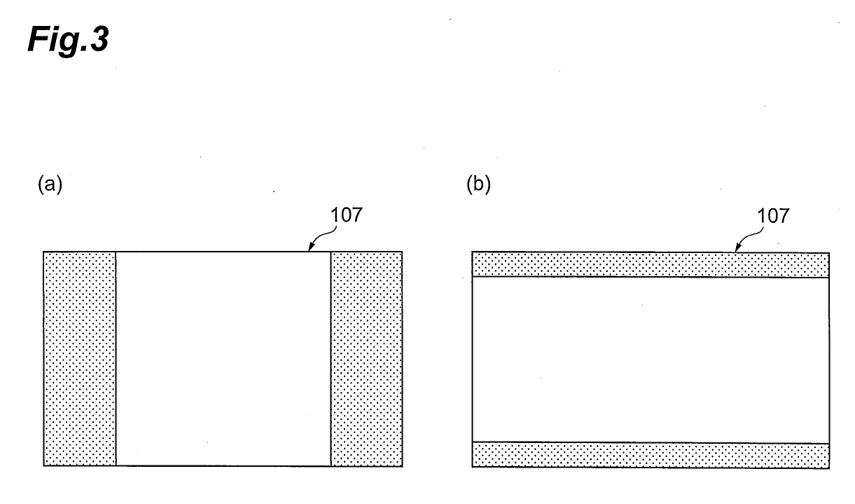

An output of each light emitting element 110 of the light emitting portion 104 is adjusted by an output control portion 111 which is connected to the light emitting portion 104. More concretely, this output control portion 111 adjusts the output of each light emitting element 110 of the light emitting portion 104 so that the contrast is optimized in accordance with a display level of video at the liquid crystal 107. Accordingly, at the light emitting portion 104, the light emitting elements 110 disposed at a region corresponding to black band-shaped portions are lighted out (or the luminance decreases significantly) by the output control portion 111 when the black band-shaped portions are displayed at circumferential edges (right and left end portions and upper and lower end portions) of the liquid crystal as shown in FIG. 3. There are advantages in aspects of the contrast and power consumption by suppressing the light emission of a part of the light emitting elements 110 of the light emitting portion 104 in accordance with the video of the liquid crystal 107. Incidentally, the black band-shaped portions occur when a video source which is long from side to side compared to a screen size such as a movie or a video of 4:3 is displayed on a 16:9 panel, and so on.

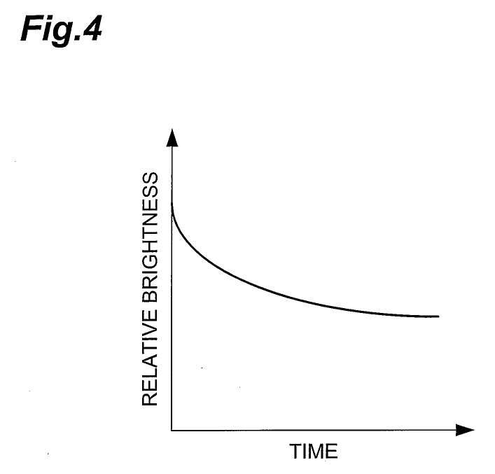

Here, the following are known that the brightness (luminance) of the light emitting element 110 decreases in accordance with light emitting time (drive time), and the more a light emission amount of the light emitting element 110 is, the larger a decreasing amount becomes as shown in FIG. 4. Incidentally, deterioration of the light emitting element 110 changes also by a drive current and operating temperature.

Namely, when the black band-shaped portion is displayed for a long time, or displayed for the number of times repeatedly as stated above, relative luminance of the light emitting elements 110 of the other portion relative to the light emitting elements 110 corresponding to the band-shaped portion decreases little by little. Concretely speaking, when the black band-shaped portions are displayed at the right and left end portions of the liquid crystal 107 as shown in (a) part of FIG. 3, a light emission frequency of the light emitting elements 110 positioning at a center portion 112b becomes high within a light emitting element region 112 where the light emitting elements 110 are disposed, and then, the luminance thereof decreases little by little compared to the luminance of the light emitting elements 110 positioning at right and left end portions (circumferential edges) 112a, 112c (refer to (a) part of FIG. 2). When the black band-shaped portions are displayed at the upper and lower end portions of the liquid crystal 107 as shown in (b) part of FIG. 3, the light emission frequency of the light emitting elements 110 positioning at a center portion 112e becomes high within the light emitting element region 112 where the light emitting elements 110 are disposed, and then, the luminance thereof decreases little by little compared to the luminance of the light emitting elements 110 positioning at upper and lower end portions (circumferential edges) 112d, 112f (refer to (b) part of FIG. 2).

As a result, a variation of deterioration becomes gradually large between the light emitting elements 110 of the light emitting portion 104, and a lack of uniformity in brightness, a lack of uniformity in luminance of the liquid crystal, or the like appear on a screen.

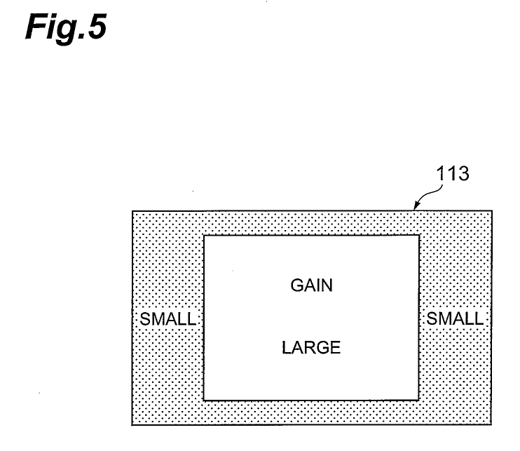

Consequently, a gain adjusting filter 113 as shown in FIG. 5 is disposed at a front surface of the light emitting portion 104 (namely, between the light emitting portion 104 and the diffusion prism sheet 105) at the liquid crystal panel unit 100. This gain adjusting filter 113 has a function to make a gain output of the region at the circumferential edges corresponding to the above-stated black band-shaped portions small, and to make a gain output of the region other than the circumferential edges (namely, the region at the center portion) large relative to the light emission from the light emitting portion 104.

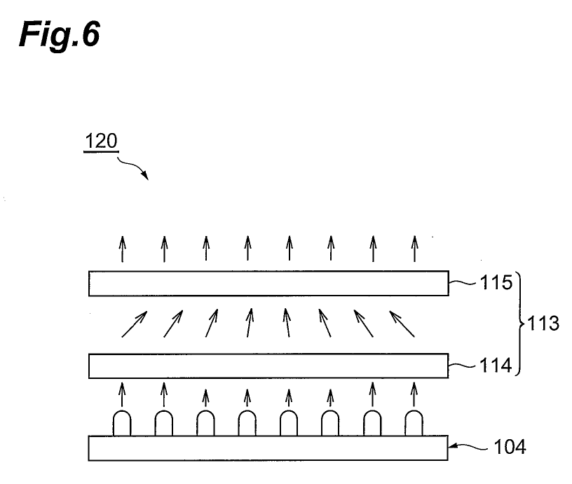

FIG. 6 is a view showing a schematic configuration of the gain adjusting filter 113. As shown in this drawing, the gain adjusting filter 113 is constituted by a first filter 114 and a second filter 115. The first filter 114 has a function to bend radiant light of the light emitting elements 110 at the circumferential edges of the light emitting portion 104 toward a center portion side. The second filter 115 has a function to convert the light transmitting through the first filter 114 into collimated light. Consequently, according to the gain adjusting filter 113 constituted by these two filters 114, 115, it becomes possible to increase the gain output of only the light emitting elements 110 positioning at the center portion of the light emitting element region 112 of the light emitting portion 104.

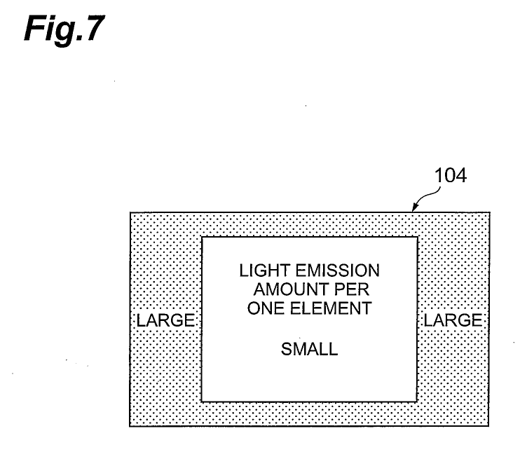

Accordingly, in the light emitting portion 104, the light emission amount (light-emission luminance) of each light emitting element 110 is adjusted by the output control portion 111 as shown in FIG. 7, to equalize the screen brightness of the liquid crystal 107 (optimize the contrast of the liquid crystal 107). Namely, the light emission amount of the light emitting elements 110 at the circumferential edges 112a, 112c, 112d, and 112f of the light emitting element region 112 corresponding to the above-stated black band-shaped portions is made large, and the light emission amount of the light emitting elements 110 at the center portions 112b, 112e of the light emitting element region 112 is made small. Concretely speaking, a light emitting pulse width of the light emitting element 110 is shortened when the light emission amount is made small, and elongated when the light emission amount is made large.

As a result, deterioration over time of the light emitting elements 110 at the center portions 112b, 112e of the light emitting element region 112 which are adjusted to make the light emission amount small is effectively suppressed.

Consequently, in a backlight control unit 120 constituted by the above-described light emitting portion 104, gain adjusting filter 113, and output control portion 111, the deterioration over time of the light emitting elements 110 at the center portions 112b, 112e is significantly suppressed as stated above, even when the drive time of the light emitting elements 110 at the center portions 112b, 112e of the light emitting element region 112 becomes long compared to the drive time of the light emitting elements 110 at the circumferential edges 112a, 112c, 112d, and 112f (namely, even when the light emitting elements at the center portion of which drive time is long and the light emitting elements at the circumferential edges of which drive time is short are mixed) resulting from the cases in which the above-stated black band-shaped portions are displayed on the screen for a long time, repeatedly displayed for the number of times, or the like. Accordingly, the variation of deterioration between the light emitting elements 110 is effectively suppressed in the backlight control unit 120.

### SECOND EMBODIMENT

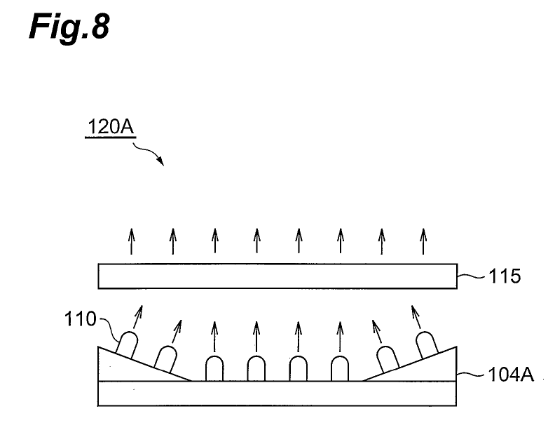

Next, a backlight control unit 120A in an aspect different from the above-stated embodiment is described with reference to FIG. 8. In the present embodiment, the above-stated first filter 114 is not used by using a light emitting portion 104A in which the light emitting elements 110 are inclined, instead of the above-stated light emitting portion 104.

In the light emitting portion 104A in the present embodiment, the light emitting elements 110 at the circumferential edges 112a, 112c, 112d, and 112f of the light emitting element region 112 are inclined toward the center portions 112b, 112e side. Accordingly, radiation directions of the light emitting elements 110 at the circumferential edges 112a, 112c, 112d, and 112f are inclined toward the center portions 112b, 112e sides. Consequently, the light emission amount (light emission luminance) of each light emitting element 110 is adjusted by the output control portion 111 as shown in FIG. 7, and the screen brightness of the liquid crystal 107 is equalized also in this light emitting portion 104A, as same as the light emitting portion 104 according to the first embodiment.

Namely, the light emission amount of the light emitting elements 110 at the circumferential edges 112a, 112c, 112d, and 112f of the light emitting element region 112 is made large, and the light emission amount of the light emitting elements 110 at the center portions 112b, 112e of the light emitting element region 112 is made small, and thereby, the even light is radiated from the light emitting element region 112 as a whole.

As a result, the deterioration over time of the light emitting elements 110 at the center portions 112b, 112e of the light emitting element region 112, of which light emission amount is adjusted to be small, is effectively suppressed as same as the first embodiment. Accordingly, the variation of deterioration between the light emitting elements 110 can be suppressed effectively also in the backlight control unit 120A according to a second embodiment.

### THIRD EMBODIMENT

Subsequently, a backlight control unit 120B in an aspect different from the above-stated embodiments is described. In the present embodiment, a light emitting portion 104B is used instead of the above-stated light emitting portions 104, 104A, and the filters 114, 115 are not used.

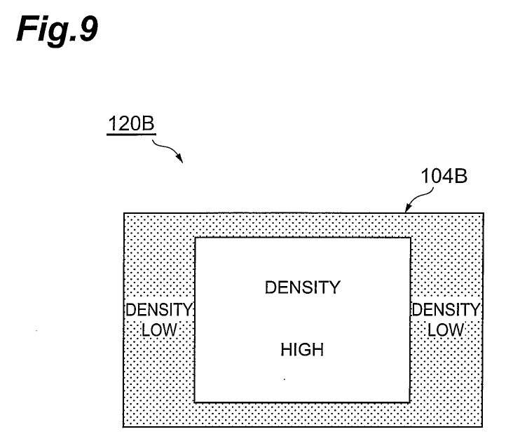

In the light emitting portion 104B, a density of the light emitting elements 110 at the light emitting element region 112 is changed as shown in FIG. 9. Concretely speaking, the density of the light emitting elements 110 at the circumferential edges 112a, 112c, 112d, and 112f of the light emitting element region 112 is lowered, and the density of the light emitting elements 110 at the center portions 112b, 112e of the light emitting element region 112 is heightened.

Namely, the light emission amount of the light emitting elements 110 at the circumferential edges 112a, 112c, 112d, and 112f of the light emitting element region 112 is made large, and the light emission amount of the light emitting elements 110 at the center portions 112b, 112e of the light emitting element region 112 is made small, and thereby, the equal light is radiated from the light emitting element region 112 as a whole. Consequently, the light emission amount of each light emitting element 110 is adjusted by the output control portion 111 as shown in FIG. 7, and the screen brightness of the liquid crystal 107 is equalized also in the above-stated light emitting portion 104B.

As a result, the deterioration over time of the light emitting elements 110 at the center portions 112b, 112e, of the light emitting element region 112 of which light emission amount is adjusted to be small, is effectively suppressed as same as the first embodiment. Accordingly, the variation of deterioration between the light emitting elements 110 can be suppressed effectively also by the backlight control unit 120B according to a third embodiment.

The present invention is not limited to the above-described embodiments, and various modifications are possible. For example, the light emitting element may be the one in which the light emission amount thereof is controlled by a current value or a voltage value without being limited to the one controlled by the pulse width. Besides, the light emitting element is not limited to the LED element, but it may be a laser diode element, an EL element, and so on.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A backlight control unit in which plural light emitting elements are disposed at one surface side, a light emitting device irradiating light of the light emitting elements from a rear surface side of a liquid crystal is held, and an output of each light emitting element of the light emitting device is adjusted so that a contrast is optimized in accordance with a video display level of the liquid crystal,
wherein densities of the light emitting elements are different between circumferential edges and a center portion at a light emitting element region where the light emitting elements of the light emitting device are disposed.

2. The backlight control unit according to claim 1,
wherein the density of the light emitting elements at the center portion is higher than the density of the light emitting elements at the circumferential edges at the light emitting element region of the light emitting device.

3. The backlight control unit according to claim 1,
wherein an output of the light emitting elements of which density is high, is smaller than an output of the light emitting elements of which density is low, between the center portion and the circumferential edges of the light emitting element region.

4. A backlight control unit in which plural light emitting elements are disposed at one surface side, a light emitting device irradiating light of the light emitting element from a rear surface side of a liquid crystal is held, and an output of each light emitting element of the light emitting device is adjusted so that a contrast is optimized in accordance with a video display level of the liquid crystal,
wherein radiation directions of the light emitting elements at circumferential edges are inclined toward a center portion side of a light emitting element region at the light emitting element region where the light emitting elements of the light emitting device are disposed.

5. A backlight control unit in which plural light emitting elements are disposed at one surface side, a light emitting device irradiating light of the light emitting element from a rear surface side of a liquid crystal is held, and an output of each light emitting element of the light emitting device is adjusted so that a contrast is optimized in accordance with a video display level of the liquid crystal, comprising:
a gain adjusting filter disposed at a front surface of the light emitting device, and increasing a gain output of only the light emitting elements positioning at a center portion of a light emitting element region where the light emitting elements of the light emitting device are disposed,
wherein an output of the light emitting elements positioning at the center portion of the light emitting element region is smaller than an output of the light emitting elements positioning at circumferential edges of the light emitting element region.
